(19) United States
(12) Patent Application Publication
(10) Pub. No.: US 2023/0177474 A1
(43) Pub. Date: Jun. 8, 2023

(54) METHOD OF AND SYSTEM FOR GENERATING CARBON COINS IN A BLOCKCHAIN SYSTEM USING PROOF OF CAPTURE

(71) Applicant: Compagnie Manufacturière CarbonCoin Inc., Longueuil (CA)

(72) Inventors: Traian Cristian IVAN, Longueuil (CA); Antoine Arbour, Blainville (CA)

(21) Appl. No.: 18/062,629

(22) Filed: Dec. 7, 2022

Related U.S. Application Data
(60) Provisional application No. 63/265,137, filed on Dec. 8, 2021.

(51) Int. Cl. G06Q 20/06; H04L 9/00

(52) U.S. Cl. CPC G06Q 20/065; H04L 9/50

(57) ABSTRACT

A system and a method is provided for converting captured greenhouse gases into a cryptocurrency using a proof of capture framework. A first node associated with a gas capture apparatus initializes a block in a blockchain system and receives gas capture sensor data from sensors during capturing of the greenhouse gases. The gas capture sensor data is logged into the initialized block. A second node associated with a gas verification apparatus is configured to access the block, authenticate the block and log gas verification sensor data acquired during unloading of the capture greenhouse gases in the block to provide an authenticated block. One or more other nodes validate the authenticated block and upon reaching a consensus insert the block in the blockchain system and generate a cryptocurrency coin which is provided to the first node.

### CROSS-REFERENCE TO RELATED APPLICATIONS

The present application claim priority to U.S. Provisional Patent Application Ser. No. 63/265,137 filed on Dec. 8, 2021, the content of which is incorporated herein by reference in its entirety.

### TECHNICAL FIELD

The present technology relates to devices for capturing and measuring greenhouse gases (GHG) and blockchain systems in general and more specifically to methods and systems for generating carbon coins in a blockchain system using a proof of capture framework.

### BACKGROUND

In the past decades, to mitigate the effects of climate change caused by the increase of greenhouse gases (GHG or tCO2e) due to fossil fuel use (e.g., coal, electricity derived from coal, natural gas and oil), deforestation and agricultural and industrial practices, national and international organizations have put an emphasis on carbon trading.

Carbon trading, which is an emissions trading approach, is a market-based system that aims to provide economic incentives to encourage organizations to reduce their environmental footprint. In this way, market mechanisms enable to drive industrial and commercial processes in the direction of low emissions or less carbon intensive approaches than those used when there is no cost to emitting GHGs into the atmosphere. Two types of global carbon markets exist, voluntary emissions reduction (VER) and certified emission reduction (CER). VER is a carbon offset that is exchanged in the over-the-counter or voluntary market for credits. Certified emissions reduction (CER) relies on emission units (or credits) created through a regulatory framework with the purpose of offsetting a project's emissions.

One type of mitigation project used by organizations to generate carbon credits or offsets that can be exchanged on the carbon market are negative emission technologies (NET) which include technology-based removal and sequestration of carbon dioxide or GHGs from the atmosphere.

However, different countries and organizations have different methods for tracking, stimulating and rewarding greenhouse gas sequestration, which prevents efficient trading due to the heterogeneity of the approaches caused by the uncertainty due to the lack of common features for describing carbon credits.

Further, some approaches may also lack transparency, which can result in corruption in an unregulated market. There is a lack of verifiable standardization and common features for the tracking and use of carbon credits for managing greenhouse gas emissions and sequestration, as well as transparency to reduce corruption and increase accuracy. These present technical challenges, as divergent computing techniques, databases and data formats are being used on a country basis or regional basis, requiring external mechanisms such as application programming interfaces (APIs) or even human intervention to determine what carbon credits might apply, which increases chances of error, decreases computing efficiency, and requires complex coding.

Thus, there is a need for a verifiable standardized system for rewarding carbon sequestration that can provide transparency to ensure accuracy and fairness in the rewarding of carbon credits, immutability of measured data and chronological mode of operation.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

Developers of the present technology have devised a blockchain framework entitled Proof of Capture, where a gas emitting entity performing capture of greenhouse gases has an associated computer system or software which acquires and analyses data measured by sensors during the physical capture of the greenhouse gases. The data from the captured greenhouse gases is encrypted into a block of a blockchain system and provided to a blockchain verification node certified by an operator. A blockchain verification node analyzes the block including the captured gas sensor data and releases for validation the sensor data added to the block in the blockchain system. The block and its data are further validated by other certified nodes in the blockchain system, which collectively validate and sign the block, and insert the block in the blockchain system. A cryptocurrency coin or “carboncoin” is then generated and provided to the worker as a reward. The carboncoin may then be exchanged on a carbon market based on the blockchain system. Trading of carboncoins may also be tracked using the same system.

The present technology aims to provide a verifiable, transparent, and standardized system for rewarding carbon/GHG sequestration with immutability of measured data and a chronological mode of operation to ensure accuracy and fairness in the rewarding of carbon credits by using a blockchain framework.

Thus, one or more embodiments of the present technology are directed to a method, a system, and a non-transitory computer-readable medium for generating carbon coins in a blockchain system using proof of capture.

In accordance with a broad aspect of the present technology, there is provided a system for converting captured greenhouse gases into cryptocurrency. The system comprises a first node, a second node and a third node connected to each other. The first node comprises a first processor connected to a first plurality of sensors. The first processor is configured for: initializing a block in a blockchain, receiving, from the first plurality of sensors, greenhouse gas capture sensor data having been acquired during capture of a given greenhouse gas, logging an indication of the greenhouse gas capture sensor data into the block to obtain an initialized block, and providing the initialized block on the blockchain. The second node comprises a second processor connected to a second plurality of sensors, the second processor being configured for: accessing the initialized block in the blockchain, authenticating the initialized block to obtain an authenticated initialized block, receiving, from the second plurality of sensors, greenhouse gas verification sensor data acquired during unloading of the given greenhouse gas, the given greenhouse gas having been received by an entity associated with the second node, logging an indication of the greenhouse gas verification sensor data into the authenticated initialized block to obtain an authenticated logged block, and providing the authenticated logged block on the blockchain, the authenticated block comprises the indication of the greenhouse gas capture sensor data and the indication of the greenhouse gas verification sensor data. The third node comprises a third processor, the third processor being configured for: accessing the authenticated logged block, validating the authenticated logged block to obtain a validated block, inserting the validated block into the blockchain system, and generating a cryptocurrency coin to be provided to the first node.

In one or more implementations of the system, the first processor is configured for: signing the initialized block using a first node private cryptographic key. The second processor is configured for: authenticating the initialized block using a first node public cryptographic key, and signing the authenticated logged block using a second node private cryptographic key. The third processor is configured for: authenticating the authenticated logged block using a second node public cryptographic key, and validating the authenticated logged block to obtain the validated block by signing the authenticated logged block using a third node private cryptographic key.

In one or more implementations of the system, the second processor is configured for executing said receiving, from the second plurality of sensors, the greenhouse gas verification sensor data acquired during the unloading of the given greenhouse gas in response to: receiving a confirmation of physical unloading of the given greenhouse gas from the entity associated with the second node.

In one or more implementations of the system, the third processor is configured for validating the authenticated block to obtain the validated block in response to: comparing at least a portion of the indication of the greenhouse gas capture sensor data with at least a portion of the indication of the greenhouse gas verification sensor data to obtain a correlation therebetween.

In one or more implementations of the system, the second processor is configured for providing the authenticated block in response to: determining, based on the indication of the greenhouse gas capture sensor data, at least an approximate quantity of the given greenhouse gas to be unloaded, receiving a quantity of unloaded given greenhouse gas, and comparing at least the approximate quantity of greenhouse gas to be unloaded with the quantity of unloaded greenhouse gas to obtain a positive quantity correlation therebetween.

In one or more implementations of the system, the second processor is further configured for: logging the approximate quantity of greenhouse gas to be unloaded, the quantity of unloaded greenhouse gas and the quantity correlation into the authenticated logged block.

In one or more implementations of the system, the system further comprises: a fourth node, the fourth node comprises a fourth processor, the fourth processor being configured for: accessing the authenticated logged block, comparing at least one of the indication of the greenhouse gas capture sensor data and the indication of the greenhouse gas verification sensor data in the authenticated block with the third node, and upon said comparing resulting in a positive outcome, signing the authenticated logged block, and transmitting a confirmation to the third processor, the confirmation thereby causing said validating of the authenticated logged block to obtain the validated block.

In one or more implementations of the system, the third processor is configured for: comparing the at least one of the greenhouse gas capture sensor data and the greenhouse gas verification sensor data in the authenticated block with the fourth node having accessed the authenticated block, obtaining a confirmation from the fourth node, the confirmation thereby causing said validating of the validating the authenticated block to obtain the validated block.

In one or more implementations of the system, the system further comprises a plurality of further nodes each comprises a respective processor, each respective processor being configured for: accessing the authenticated logged block, comparing the at least one of the indication of the greenhouse gas capture sensor data and the indication of the greenhouse gas verification sensor data in the authenticated logged block with each of at least the third processor and the fourth processor having accessed the authenticated block, and upon said comparing resulting in a positive outcome, signing the authenticated logged block, and transmitting a confirmation to the third processor, the confirmation thereby causing said validating of the authenticated logged block to obtain the validated block.

In one or more implementations of the system, said validating is executed upon receiving a confirmation from at least 50% of nodes.

In one or more implementations of the system: the first node is associated with a gas capture apparatus, the gas capture apparatus comprises the first plurality of sensors, the gas capture apparatus being configured for capturing the greenhouse gases, the second node is associated with a gas verification apparatus, the gas verification apparatus comprises the second plurality of sensors, the gas verification apparatus being configured for unloading and verifying the greenhouse gases captured by the gas capture apparatus.

In one or more implementations of the system, the greenhouse gas capture sensor data comprises at least one of: electroconductivity, temperature, concentration, airflow, and pressure measured during capture of the given greenhouse gas.

In one or more implementations, the first processor is operatively connected to a first non-transitory storage medium storing computer-readable instructions which cause the first processor to execute the aforementioned operations of the first processor. The second processor is operatively connected to a second non-transitory storage medium storing computer-readable instructions which cause the second processor to execute the aforementioned operations of the second processor. The third processor is operatively connected to a third non-transitory storage medium storing computer-readable instructions which cause the third processor to execute the aforementioned operations of the third processor.

In accordance with a broad aspect of the present technology, there is provided a method for converting captured greenhouse gases into a cryptocurrency, said method comprising: initializing, by a first node, a block in a blockchain system, receiving, by the first node from a first plurality of sensors, greenhouse gas capture sensor data having been acquired during capture of a given greenhouse gas, logging, by the first node, an indication of the greenhouse gas capture sensor data into the block to obtain an initialized block, providing, by the first node, the initialized block, accessing, by a second node, the initialized block, authenticating, by the second node, the initialized block to obtain an authenticated block, receiving, by the second node from a second plurality of sensors, greenhouse gas verification sensor data having been acquired during unloading of the given greenhouse gas, the given greenhouse gas having been received by an entity associated with the second node, logging, by the second node, an indication of the greenhouse gas verification sensor data into the authenticated block to obtain an authenticated logged block, providing, by the second node, the authenticated logged block, the authenticated logged block comprises the indication of the greenhouse gas capture sensor data and the indication of the greenhouse gas verification sensor data, accessing, by at least a third node, the authenticated logged block, validating, by at least the third node, the authenticated logged block to obtain a validated block, inserting, by the third node, the validated block into the blockchain, and generating, by at least the third node, a cryptocurrency coin to be provided to the first node.

In one or more implementations of the method, the method further comprises, prior to said inserting the validated block into the blockchain: signing, by the first node, the initialized block using a first node private cryptographic key, authenticating, by the second node, the initialized block using a first node public cryptographic key, and signing, by the second node, the authenticated logged block using a second node private cryptographic key, and authenticating, by the third node, the authenticated logged block using a second node public cryptographic key, and signing, by the third node, the validated block using a third node private cryptographic key.

In one or more implementations of the method, said receiving, from the second plurality of sensors, the greenhouse gas verification sensor data acquired during the unloading of the given greenhouse gas is executed in response to: receiving a confirmation of physical unloading of the given greenhouse gas.

In one or more implementations of the method, said validating the authenticated block to obtain the validated block is executed in response to: comparing, by the third node, at least a portion of the greenhouse gas capture sensor data with at least a portion of the greenhouse gas verification sensor data to obtain a correlation therebetween.

In one or more implementations of the method, said providing, by the second node, the authenticated block is performed in response to: determining, by the second node, based on the greenhouse gas capture sensor data, at least an approximate quantity of greenhouse gas to be unloaded, receiving, by the second node, a quantity of unloaded greenhouse gas, and comparing, by the second node, at least the approximate quantity of greenhouse gas to be unloaded with the quantity of unloaded greenhouse to obtain a positive quantity correlation therebetween.

In one or more implementations of the method, the method further comprises: logging the approximate quantity of greenhouse gas to be unloaded, the quantity of unloaded greenhouse gas and the quantity correlation into the authenticated block.

In one or more implementations of the method, the method further comprises, prior to said inserting the validated block into the blockchain: accessing, by a fourth node, the authenticated block, comparing, by the fourth node, at least one of the greenhouse gas capture sensor data and the greenhouse gas verification sensor data in the authenticated block with the third node, and upon said comparing resulting in a positive outcome, signing, by the fourth node, the authenticated block, and transmitting, by the fourth node, a confirmation to the third processor, the confirmation thereby causing said validating of the authenticated block to obtain the validated block.

In one or more implementations of the method, the method further comprises, prior to said inserting the validated block into the blockchain: comparing, by the third node, the at least one of the greenhouse gas capture sensor data and the greenhouse gas verification sensor data in the authenticated block with a fourth node having accessed the authenticated block, and obtaining, by the third node, a confirmation from the fourth node, the confirmation thereby causing said validating of the validating the authenticated block to obtain the validated block.

In one or more implementations of the method, the method further comprises: accessing the authenticated block, comparing the at least one of the greenhouse gas capture sensor data and the greenhouse gas verification sensor data in the authenticated block with a fourth node having accessed the authenticated block, and upon said comparing resulting in a positive outcome, signing the authenticated block, and transmitting a confirmation to the third processor, the confirmation thereby causing said validating of the authenticated block to obtain the validated block.

In one or more implementations of the method, said validating is executed upon receiving a confirmation from at least 50% of nodes.

In one or more implementations of the method, the first node is associated with gas capture apparatus, the gas capture apparatus comprising the first plurality of sensors, the gas capture apparatus being configured for capturing the greenhouse gases.

In one or more implementations of the method, the second node is associated with gas verification apparatus, the gas verification apparatus comprising the second plurality of sensors, the gas verification apparatus being configured for unloading and verifying the greenhouse gases captured by the gas capture apparatus.

In one or more implementations of the method, the gas capture apparatus and the first node are located at a first physical location and the gas verification apparatus and the second node are located at second physical location, the second physical location being remote from the first physical location.

In one or more implementations of the method, the greenhouse gas capture sensor data comprises at least one of: electroconductivity, temperature, concentration, airflow, and pressure measured during capture of the given greenhouse gas.

In accordance with a broad aspect of the present technology, there is provided a method for converting captured greenhouse gases into a cryptocurrency, the method comprising: receiving, at a first node, through an inlet circuit ambient air of a given environment, capturing, at a gas capture device, a given greenhouse gas contained in the received ambient air, measuring, using a plurality of sensors, parameters related to the captured given greenhouse gas to obtain capture sensor data, initializing a block in a blockchain system using at least the capture sensor data and a timestamp, providing the captured given greenhouse gas and the block to a verification node for validation, and receiving, at the first node, a reward cryptocurrency based on validated captured given gas and validated sensor data.

In one or more embodiments of the method, the method further comprises: receiving the captured given gas and the block at the verification node, measuring, using verification sensors during unloading of the captured greenhouse gases, parameters related to the captured given greenhouse gas to obtain validation sensor data, validating the capture sensor data using a validation model, signing the block in the blockchain based on the validation sensor data, and transmitting the block for insertion into the blockchain system.

In one or more embodiments of the method, the method further comprises: receiving the block at a validator node, validating the block, inserting the validated block into the blockchain system, and generating the reward corresponding to the validated block, the reward to be provided to the first node.

In one or more implementations of the method, the method further comprises packaging the given captured greenhouse gas for storage.

In one or more implementations of the method, said capturing is performed by reacting the received ambient air with a reactant to capture the given greenhouse gas.

In one or more implementations of the method, the given greenhouse gas is carbon dioxide (CO₂) and the reactant is monoethanolamine (MEA).

In one or more implementations of the method, the captured given gas is provided to the validator node through a gas transport network comprising at least one of a pipeline, land vehicles, aircrafts and watercrafts.

In one or more implementations of the method, the block is signed with a private key associated with the first node and retrieved by the validator node using a public key associated with the first node.

In one or more implementations of the method, the measured parameters comprise at least one of: electroconductivity, temperature, concentration, airflow, and pressure measured during capture of the given greenhouse gas.

### Terms and Definitions

In the context of the present specification, a “server” or a “node” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to, audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting embodiments of the present technology.

FIG. 2 depicts a schematic diagram of a gas capture and communication system in accordance with one or more non-limiting embodiments of the present technology.

FIG. 3 depicts a schematic diagram of a blockchain system using proof of capture, the blockchain system being implemented within the gas capture and communication system of FIG. 2 in accordance with one or more non-limiting embodiments of the present technology.

FIG. 4 depicts a diagram of an adsorption reaction of carbon dioxide (CO₂) using monoethanolamine (MEA) in accordance with one or more non-limiting embodiments of the present technology.

FIG. 5A depicts a flow chart of a method for generating a block and obtaining a carbon coin in a blockchain system using proof of capture, the method being executed by a worker node (first node), in accordance with one or more non-limiting embodiments of the present technology.

FIG. 5B depicts a flow chart of a method of authentication of a block generated by a worker node using proof of capture, the method being executed by a verificator node (second node), in accordance with one or more non-limiting embodiments of the present technology.

FIG. 5C depicts a flow chart of a method of rewarding a worker node with a carbon coin in blockchain system using proof of capture, the method being executed by at least one validator node (third node) in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

Electronic Device

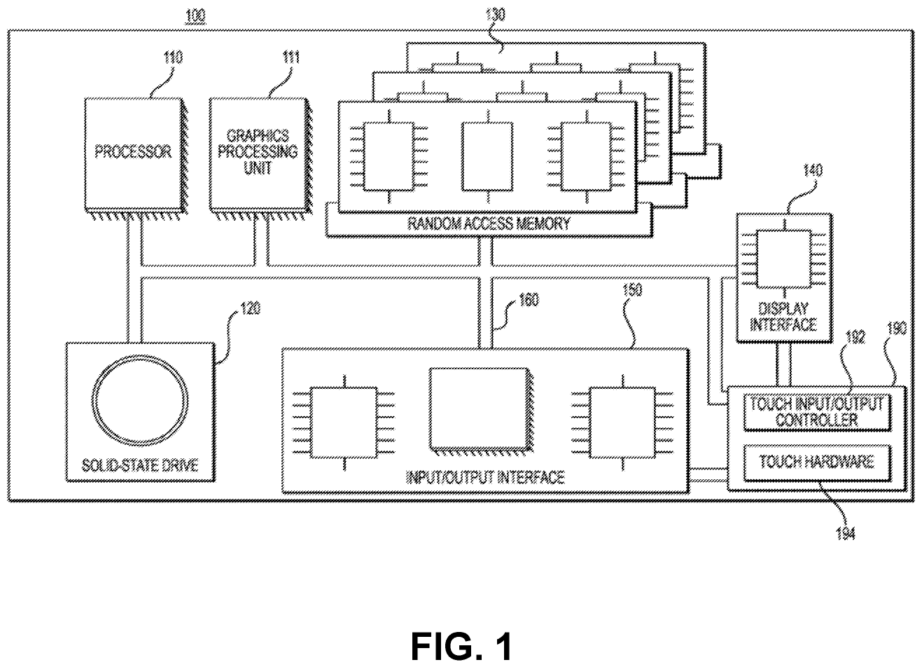

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190. It will be appreciated that in some embodiments of the present technology, for example when the electronic device 100 is implemented as a server, the electronic device 100 may not comprise a display interface 140 and/or an input/output interface 150.

According to implementations of the present technology, the solid-state drive 120 stores program instructions suitable for being loaded into the random-access memory 130 and executed by the processor 110 and/or the GPU 111 for generating carbon coin in a blockchain system using proof of capture. For example, the program instructions may be part of a library or an application.

The electronic device 100 may be implemented as a server, a desktop computer, a laptop computer, a tablet, a smartphone, a personal digital assistant, or any device that may be configured to implement the present technology, as it may be understood by a person skilled in the art.

System

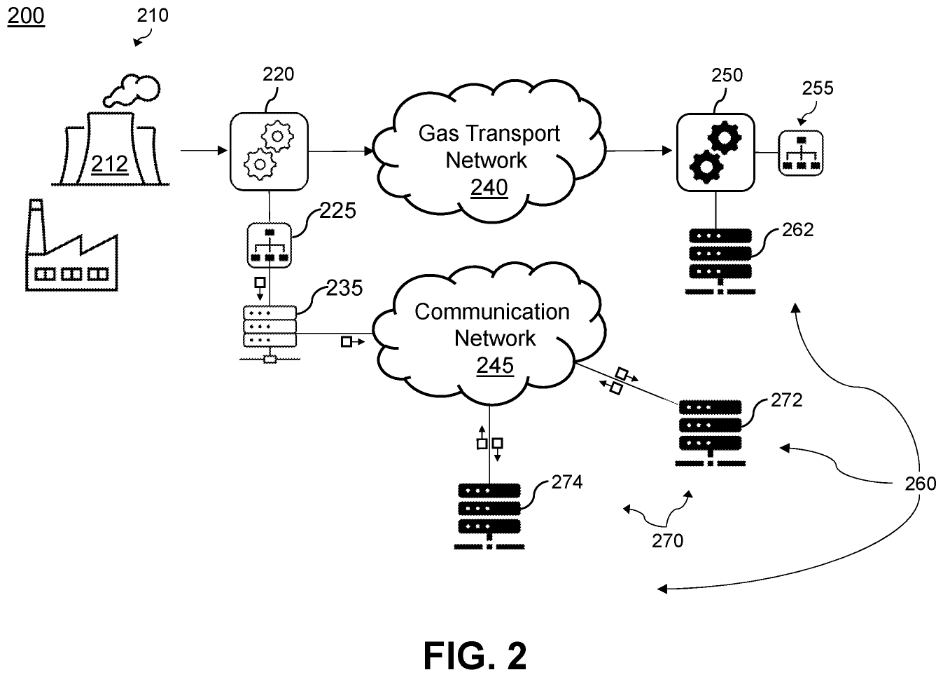

Referring to FIG. 2, there is shown a schematic diagram of a gas capture and communication system 200, which will be referred to as the system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia: a plurality of gas emitting entities 210, a given gas emitting entity 212 being associated with a respective gas capture apparatus 220 and a respective worker node 235, and a plurality of verificator nodes 260, the plurality of verificator nodes 260 comprising: at least one verificator node 262 associated with a respective gas verification apparatus 250, and a plurality of validator nodes 270 (only two validator nodes 272, 274 depicted in FIG. 2).

Each given gas emitting entity 212 associated with a gas capture apparatus 220 is connected to one or more gas verification apparatuses such as the gas verification apparatus 250 over a gas transport network 240.

Each given worker node 235 is connected to the plurality of verificator nodes 260 over a communication network 245.

Gas Emitting Entity

Each given gas emitting entity 212 may be any type of entity that emits inter alia greenhouse gases (GHG) that can be sequestrated using the gas capture apparatus 220. It will be appreciated that greenhouse gases may include, but are not limited to, carbon dioxide (CO₂), methane (CH₄), nitrous oxide (N₂O), ozone (O₃) and combinations thereof.

As a non-limiting example, the given gas emitting entity 212 may be a factory, a commercial or residential building, means of transport, a power generation station, a farm and the like. It will be appreciated that the present technology is not limited to the type of gas emitting entity 212.

Each given gas emitting entity 212 of the plurality of gas emitting entities 210 may include or may be operatively connected to a respective gas capture apparatus 220.

Gas Capture Apparatus

The gas capture apparatus 220 is configured to inter alia sequestrate greenhouse gases emitted by the gas emitting entity 212. In one or more embodiments, the gas capture apparatus 220 is configured to capture and store, at least temporarily, the greenhouse gases emitted by the gas emitting entity 212.

Each gas capture apparatus 220 is associated with at least one unique identifier (ID). In one or more embodiments, the unique ID may be provided in the form a quick response (QR) code.

As such, the gas emitting entity 212 is associated with the gas capture apparatus 220. In one or more embodiments, the gas capture apparatus 220 is integrated into, owned and operated by the gas emitting entity 212. In one or more other embodiments, the gas capture apparatus 220 is provided to the gas emitting entity 212 and is not owned by the gas emitting entity 212. It will be appreciated that the gas capture apparatus 220 may be operatively and fluidly connected to the gas emitting entity 212 using different components known in the art such as inlets, outlets, pipes, pumps, pistons, and the like.

The gas capture apparatus 220 may use one or more of physical processes, chemical processes, and electrochemical processes to capture and store the greenhouse gases. It will be appreciated that the captured greenhouse gases may be sequestrated and stored into a container, or may be provided via a pipeline over a gas transport network 240 to another entity for storage.

As a non-limiting example, the gas capture apparatus 220 may sequestrate the greenhouse gas by using one or more of pressure swing adsorption, vacuum swing adsorption, temperature swing adsorption, cryogenic distillation, solvent-based separation, membrane-based separation and the like.

In one or more embodiments, the gas capture apparatus 220 is operable to sequestrate captured greenhouse gases into one or more containers or receptacles having a given capacity (volume or weight). In such embodiments, the gas capture apparatus 220 is associated with a threshold capacity, which may be based on a capacity of one receptable or a set of receptacles. In one or more embodiments, the threshold capacity may be based on a time period.

In one or more embodiments, the gas capture apparatus 220 is configured to capture greenhouse gases by sparging of carbon dioxide (CO₂) with ethanolamine (MEA). The gas capture apparatus 220 may include inlets, gas circuits, reactions jars, heaters, valves, pumps and the like.

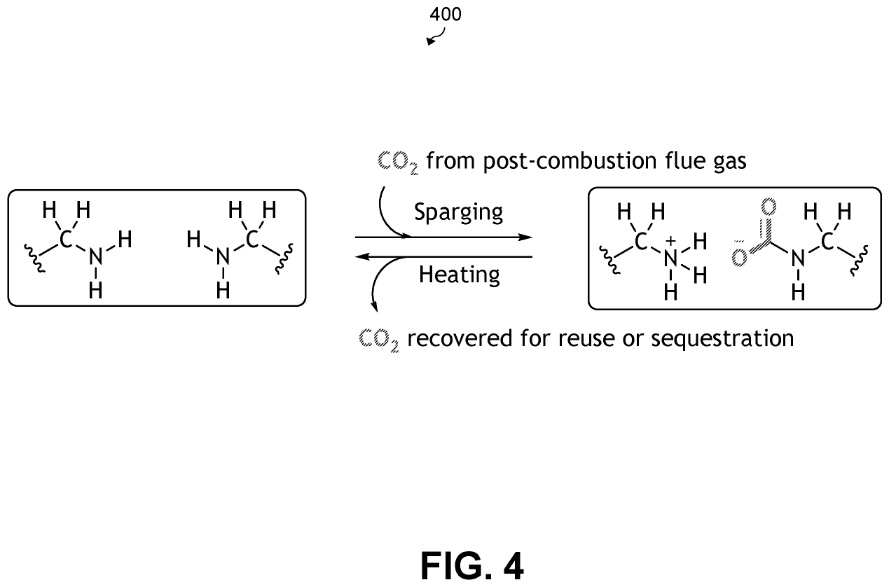

With brief reference to FIG. 4, there is illustrated a non-limiting example of an adsorption reaction 400 of carbon dioxide (CO₂) using monoethanolamine (MEA) in accordance with one or more non-limiting embodiments of the present technology. More details about the absorption reaction are available in paper entitled “Amine-Based CO2 Capture Technology Development from the Beginning of 2013 A Review” by Dutcher, B.; Fan, M.; Russell, A. G. ACS Applied Materials & Interfaces 2015, 7 (4), 2137-2148, which is incorporated herein by reference in its entirety.

Turning back to FIG. 2, the gas capture apparatus 220 comprises a plurality of sensors 225.

Plurality of Sensors

The plurality of sensors 225 are configured to inter alia: (i) measure data relating to the capture of the greenhouse gases by the gas capture apparatus 220; (ii) optionally calculate parameters related to the capture of greenhouse gases; (iii) transmit the gas capture sensor data and related parameters to the worker node 235.

The plurality of sensors 225 may include thermometers, pressure sensors or transducers, flowmeters, electrical conductivity meters, spectrophotometer and the like.

The plurality of sensors 225 may measure, directly or indirectly, one or more of: temperature, pressure, flow, electroconductivity, greenhouse gas quantity or concentration, reactant quantity or concentration, byproducts quantity or concentration and any other relevant data that can be measured during capture of the given greenhouse gas. In short, the data measured by the plurality of sensors 225 depends on the techniques used to capture greenhouse gases by the gas capture apparatus 220. As a non-limiting example, the measured data may include any data related to the greenhouse gas, the reactant, and the by-products that can be measured during the gas capture process.

As a non-limiting example, the plurality of sensors 225 may include nondispersive infrared (NDIR) CO₂ sensors, photoacoustic sensors, chemical sensors, and the like.

In one or more embodiments, a given one of the plurality of sensors 225 may have processing capabilities (e.g., processor which may include one or more of a CPU, microprocessor(s), microcontroller(s), etc.) to perform processing of sensed data.

One or more of the plurality of sensors 225 may be provided with a physical and/or electrical tamper proof mechanism. Additionally or alternatively, the plurality of sensors 225 may be provided with digital or software-based tamper proof mechanisms so as to prevent tampering of the sensed gas capture data by third parties.

Each of the plurality of sensors 225 may be associated with a unique ID and/or unique address. One or more of the plurality of sensors 225 may sign measured data with a respective cryptographic key or by using a checksum.

Worker Node

The worker node 235 is in the form of a computing device comprising inter alia a processor (such as the processor 110 and/or the GPU 111 of the electronic device 100 of FIG. 1), the processor being operatively connected to a non-transitory storage medium (such as the solid-state drive 120 and/or the random-access memory 130 of the electronic device 100 of FIG. 1) and one or more communication interfaces.

It will be appreciated that the number of gas emitting entities and respective worker nodes is not limited, and the number of gas emitting entities and respective worker nodes may include dozens, hundreds or thousands of verificator nodes.

The worker node 235 is configured to perform functions related to processing and management of the blockchain, which includes inter alia functions specific to greenhouse gas capture, data logging and block generation.

The worker node 235 is associated with the gas capture apparatus 220. Each worker node 235 may have a unique identifier and/or unique address. The worker node 235 is connected to the plurality of sensors 225 of the gas capture apparatus 220. The worker node 235 may be connected via respective wired or wireless communication links to one or more of the plurality of sensors 225 to receive data therefrom.

In one or more embodiments, the worker node 235 may be provided by or certified by an authority or operator of the system 200.

In the context of the present technology, the worker node 235 may be awarded a cryptographic carbon credit upon validation of physical sequestration of the greenhouse gases and validation by the verificator node 262 and validator nodes 270. The cryptographic carbon credit may then be traded on a carbon exchange market by the operator associated with the gas emitting entity 212.

In one or more embodiments, the worker node 235 may be located in physical proximity to the gas capture apparatus 220. In one or more other embodiments, the worker node 235 may be located within an enclosure of the gas capture apparatus 220. It will be appreciated that the communication link between the worker node 235 and the gas capture apparatus 220 may be a physical communication link or a wireless communication link.

In some embodiments, the gas capture apparatus 220, the worker node 235 and optionally the gas emitting entity 212 are integrated into a single unit or single physical location, and may be collectively referred to as the worker node 235.

In embodiments where the worker node 235 is in physical proximity and has a wired communication link to the gas capture apparatus 220 and/or to the plurality of sensors 225 for receiving data therefrom, the wired communication link may be provided with a tamper proof mechanism. As a non-limiting example, the gas capture apparatus 220 and the worker node 235 may be certified and/or installed by an authority providing the block chain system of the present technology or another entity associated therewith to prevent fraud.

In one or more other embodiments, the worker node 235 may be located remotely from the gas capture apparatus 220 and may be communicatively coupled to at least the plurality of sensors 225 of the gas capture apparatus. In such embodiments, the worker node 235 has a secure connection to the plurality of sensors 225.

The worker node 235 is configured to inter alia: (i) receive gas capture sensor data from the plurality of sensors 225, the gas capture sensor data having been acquired during capture of greenhouse gases by the gas capture apparatus 220; (ii) receive additional data related to the gas capture apparatus 220 and gas capture sensor data; (iii) maintain a worker node wallet; (iv) initialize a block in a blockchain system; (v) stream the gas capture sensor data and the additional data to the block in the blockchain system; (vi) upon reaching a predetermined threshold, sign the block with a worker private cryptographic key; (vii) provide the block on the blockchain, the block having a pending status; and (viii) receive one or more carbon coins from validator nodes 270 upon validation of the captured data.

In one or more alternative embodiments, the worker node 235 may initialize the block at another time during or after capture of the greenhouse gases by the gas capture apparatus 220.

The worker node 235 receives gas capture data sensed by the plurality of sensors 225 of the gas capture apparatus 220 during the capture and sequestration of the greenhouse gases. In one or more embodiments, the gas capture sensor data may be streamed in real-time or almost real-time by the plurality of sensors 225 to the worker node 235. In one or more other embodiments, the gas capture sensor data may be transmitted to the worker node 235 when the capturing and sequestration is completed by the gas capture apparatus 220. It will be appreciated that that a combination of streaming and buffering of the gas capture sensor data may be used.

Upon reaching a predetermined threshold during capture of the greenhouse gases by the gas capture apparatus 220, the worker node 235 is configured to sign the block with a worker private cryptographic key.

In one or more embodiments, the predetermined threshold is based on a physical limit of the gas capture apparatus 220 in capturing greenhouse gases. In one or more alternative embodiments, the predetermined threshold is based on computing capabilities of the worker node 235, computing capabilities of other nodes in the system 200, physical capability of the gas capture apparatus 220, physical capabilities of the gas verification apparatus 250 or a combination thereof. In one or more other embodiments, the predetermined threshold may be based on time of capture.

The worker node 235 maintains or is associated with a worker node cryptographic wallet (not depicted in FIG. 2) comprising cryptographic keys. The worker node cryptographic wallet comprises a worker private cryptographic key and a worker public cryptographic key, which will be described in more detail herein below.

Developers of the present technology have performed an experiment with a prototype of a gas capture apparatus 225 based on the adsorption reaction 400 illustrated in FIG. 4. The prototype gas capture comprised an inlet for receiving ambient air or pure CO₂, a first circuit comprising pumps, valves to direct the CO₂ to a first reaction jar, the first reaction jar including MEA for performing sparging of CO₂ with MEA. The prototype gas capture apparatus comprised a first set of sensors operatively connected to the first reaction jar for measuring electroconductivity and temperature, and a second circuit comprising a condenser, pumps, valves to direct the CO₂ to a second reaction jar. The prototype gas capture apparatus comprised a second set of sensors operatively connected to the second circuit for measuring concentration, flow, etc. of CO₂ in real time, and a second reaction jar operatively connected to heaters for heating the CO₂ and MEA to release the CO₂. The prototype gas capture apparatus comprised a third set of sensors operatively connected to the second reaction jar for measuring temperature, electroconductivity, concentration, flow, etc. of CO₂ in real time and an outlet operatively connected to a subsystem for receiving, storing and weighing the CO₂. A computer comprising a processor operatively connected to each of the first, second and third set of sensors, received the CO₂ related measurement therefrom.

Gas Verification Apparatus

The gas verification apparatus 250 is configured to inter alia: (i) receive sequestrated greenhouse gas from gas emitting entities associated with worker nodes such as the gas emitting entity 212 associated with the worker node 235; (ii) upon receiving an indication, unload the sequestrated greenhouse gases; (iii) perform measurements, via a plurality of verification sensors 255, on the sequestrated greenhouse gases before, during, and after the unloading thereof to obtain gas verification sensor data; (iv) provide an indication of capture sensor data measurements and/or the determined total amount of captured gas to the verificator node 262.

In one or more embodiments, the gas verification apparatus 250 may be provided by or certified by an authority or operator of the system 200. In one or more embodiments, the gas verification apparatus 250 may be integrated to the verificator node 262 which may be referred to collectively as the verificator node 262.

The gas verification apparatus 250 may perform a variety of measurements on the received greenhouse gas, for instance by measuring the mass of the received greenhouse gases, the concentration of the received greenhouse gases with a given volume, the purity of the received greenhouse gases and the like. The purpose of the measurements is to confirm the physical presence of the captured greenhouse gases.

The gas verification apparatus 250 has the plurality of verification sensors 255 to perform the measurements during and after unloading of the captured greenhouse gases so as to validate the physical quantity of greenhouse gases captured by the gas capture apparatus 220 associated with the worker node 235, as well as quantifying losses during the unloading process. The gas verification apparatus 250 thus outputs, via the plurality of verification sensors 255, gas verification sensor data.

It will be appreciated that the verification sensor data depends on the type of sensor and methods used to unload the greenhouse gas.

Verificator Node

The verificator node 262 is a computing apparatus associated with the gas verification apparatus 250. The verificator node 262 is in the form of a computing device comprising inter alia a processor (such as the processor 110 and/or the GPU 111 of the electronic device 100 of FIG. 1), the processor being operatively connected to a non-transitory storage medium (such as the solid-state drive 120 and/or the random-access memory 130 of the electronic device 100 of FIG. 1) and one or more communication interfaces.

It will be appreciated that the number of verificator nodes in the plurality of verificator nodes 260 is not limited, and the plurality of verificator nodes may include dozens, hundreds or thousands of verificator nodes.

The verificator node 262 is configured to inter alia: (i) retrieve the block and gas capture sensor data from the blockchain; (ii) validate the measurements based on mathematical models; (iii) access a verification public key associated with the worker node private key of the worker node 235 and/or the gas capture apparatus 220; (iv) authenticate the worker node 235 and/or verify data integrity of the gas capture sensor data by the plurality of sensors 225; (v) compile and verify the gas capture sensor data; (vi) receive an indication of measurements and quantity during unloading of the sequestrated greenhouse gases by the plurality of verification sensors 255; (vii) validate, at least partially, the gas capture sensor data and the gas verification sensor data, by signing the block with a verificator private key; and (viii) provide the block on the blockchain for validation by validator nodes 270.

The verificator node 262 comprises, or is associated with, a respective verificator cryptographic wallet, which will be described in more detail herein below.

In one or more embodiments, the verificator node 262 executes mathematical models to one or more of the gas capture sensor data and the gas verification sensor data. Additionally or alternatively, the verificator node 262 executes one or more machine learning (ML) models having been trained to correlate and verify the gas capture sensor data by the plurality of sensors 225 of the gas capture apparatus 220 with the gas verification sensor data of the plurality of verification sensors 255 of the gas verification apparatus 250. It will be appreciated that the models may be trained based on parameters associated with the type of reactions and techniques used to sequestrate greenhouse gases as well as techniques and parameters used by the gas verification apparatus 250.

In one or more embodiments, the verificator node 262 may also execute ML models on the blockchain to learn from historical capture sensor data and verification sensor data in each block so as to provide recommendations. In such embodiments, the verificator node 262 executes a gas loss function to track losses and provide recommendations.

It is contemplated that in some embodiments, ML models may be used to analyze greenhouse gases transportation data so as to provide recommendations to improve routes and techniques used for transporting sequestrated greenhouse gases. Further, ML models may also be used to detect potentially fraudulent data in capture sensor data and verification data and to optimize the systems, components and processes described herein.

Validator Node

The plurality of validator nodes 270 are a portion (i.e. subset) of the verificator nodes 260 not having participated in the physical verification and unloading of the captured greenhouse gases. It will be appreciated that some of the validator nodes 270 may be associated with respective gas verification apparatuses, however this does not need to be so in each and every embodiment of the present technology.

It will be appreciated that the number of validator nodes 270 is not limited.

Each validator node 272, 274 is configured to inter alia: (i) receive the validation data and the block from the verificator node 262; (ii) validate the block; (iii) provide a confirmation to the worker node 235; (iv) forge the block in the blockchain; and (v) generate a carboncoin reward.

In the context of the present technology, the plurality of validator nodes 270 perform validation of the block after signature by the verificator node 262. In one or more embodiments, the validator nodes 270 perform validation by voting and reaching a consensus.

In one or more alternative embodiments, at least one of the verificator node 262, the validator node 272 and the worker node 235 receives a reward upon the forging of the block. The reward may be, for instance, an amount of fiat funds corresponding to a defined percentage of the value of the generated coin, a coin or a fraction thereof, rights in the blockchain and the like.

In a given event where the measurements (i.e., sensor data) from the worker nodes 235 and the verificator nodes 260 correspond to the sequestrated greenhouse gases, and that the criteria for forging a block are met, the plurality of validator nodes 270 forge the block initialized and provided by the worker node 235. It will be appreciated that typically, the forging of a block involves broadcasting to a plurality of nodes sharing the blockchain the forged block, and by doing so updating the ledger on the recent transactions.

Once the block is forged and the plurality of validator nodes 270 have approved the measurements and the validation made by the gas verification apparatus 250, the worker node 235 receives a cryptocurrency unit or coin (hereinafter “carboncoin”) corresponding to the sequestrated amount of greenhouse gases. The carboncoin may then be exchanged on a market with other worker nodes or other participating entities.

Gas Transport Network

The gas transport network 240 may be any type of means that is used to physically transfer greenhouse gases from the gas capture apparatus 220 to the gas verification apparatus 250.

In one or more embodiments, the gas transport network 240 may comprise one or more means of transportation for moving sequestrated gas from the gas capture apparatus 220 to the gas verification apparatus 250. As a non-limiting example, in embodiments where greenhouse gases are sequestrated and stored in containers, the gas transport network 240 may include land vehicles such as trucks and trains, aircrafts such as airplanes and watercrafts such as boats.

In one or more alternative embodiments, the gas transport network 240 may include one or more pipeline networks, and one or more gas emitting entities 210 and gas capture apparatus 220 may be connected to the gas verification apparatus 250 via pipelines.

Communication Network

In some embodiments of the present technology, the communications network 245 is the Internet. In alternative non-limiting embodiments, the communication network 245 can be implemented as any suitable local area network (LAN), wide area network (WAN), a private communication network or the like. It should be expressly understood that implementations for the communication network 245 are for illustration purposes only. How a respective communication link (not numbered) between each of the worker node 235 and the plurality of verificator nodes 260 is implemented will depend inter alia on how each of the worker node 235 and the plurality of verificator nodes 260 are implemented.

The communication network 245 may be used in order to transmit data packets amongst the worker node 230 and the plurality of verificator nodes 260. For example, the communication network 245 may be used to transmit requests, sensor measurements, and blockchain related information between the worker node 230 and the plurality of verificator nodes 260.

Blockchain System using Proof of Capture

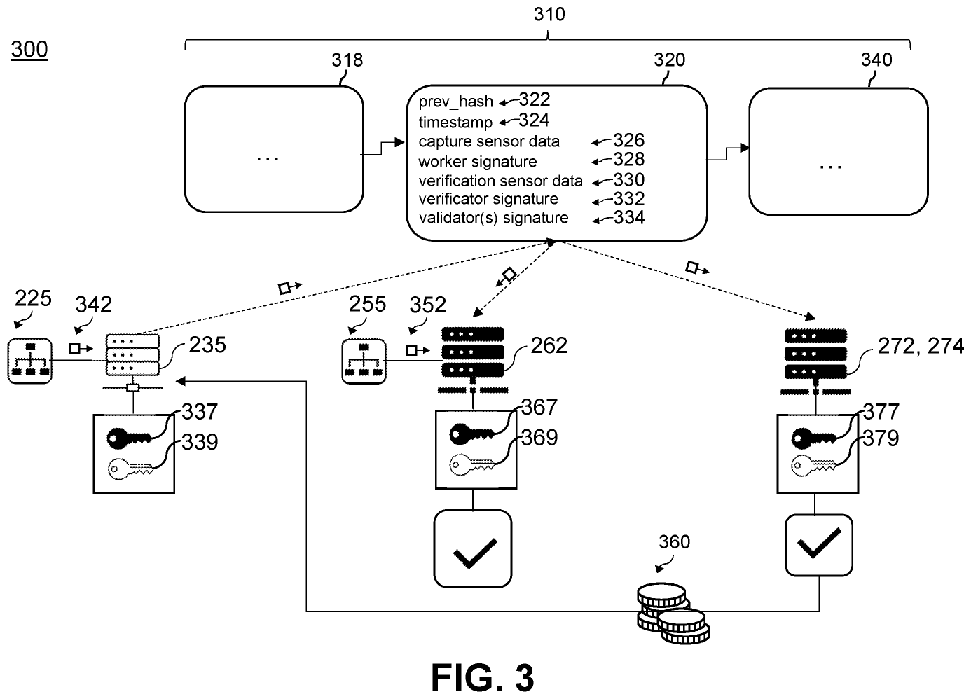

With reference to FIG. 3, there is shown a schematic diagram of a blockchain system 300 implemented within the system of FIG. 2 in accordance with one or more non-limiting embodiments of the present technology.

The blockchain system 300 is implemented within the system 200 of FIG. 2 using the communication network 245. It will be appreciated that the blockchain system 300 comprises a plurality of layers including infrastructure layers, networking layers, consensus layers, data layers and application layers.

The blockchain system 300 is a decentralized network of nodes that uses a distributed ledger that serves as public financial transaction database for exchange of a cryptocurrency or carboncoins, which is based on a proof of capture framework, where entities that successfully capture and sequestrate carbon dioxide or greenhouse gases in addition to gas capture sensor data written in a block of a blockchain 310 may be rewarded with carbon coins upon validation by other participating entities or nodes in the blockchain system 300 (i.e., via consensus). Carbon coins may be traded on the global carbon market via the blockchain 310 by gas emitting entities 210.

The distributed ledger 310 or blockchain 310 is schematically illustrated as comprising a plurality of blocks (only three blocks 318, 320, 340 illustrated in FIG. 3). Blocks hold, among other things, batches of valid transactions of carbon coins and sensor data related to the capture and validation of greenhouse gases such as, but not limited to, CO₂. It will be appreciated that parameters of the blockchain 310 related to its structure and implementation (e.g., block size, number of nodes, storage algorithms, signature protocols, access protocols, etc.) are predetermined.

In one or more embodiments, transactions of carboncoins are hashed and encoded using a storage algorithm such as a Merkle tree. Other non-limiting examples of storage algorithms include MerklePatriciaTries and linked lists. Each block in the blockchain 310 includes the cryptographic hash of the prior block in the blockchain 310, linking the two. It will be appreciated that this iterative process confirms the integrity of the previous block, all the way back to the initial block, also known as genesis block. To ensure the integrity of a block and the data contained in it, the block is usually digitally signed using a cryptographic key or a checksum.

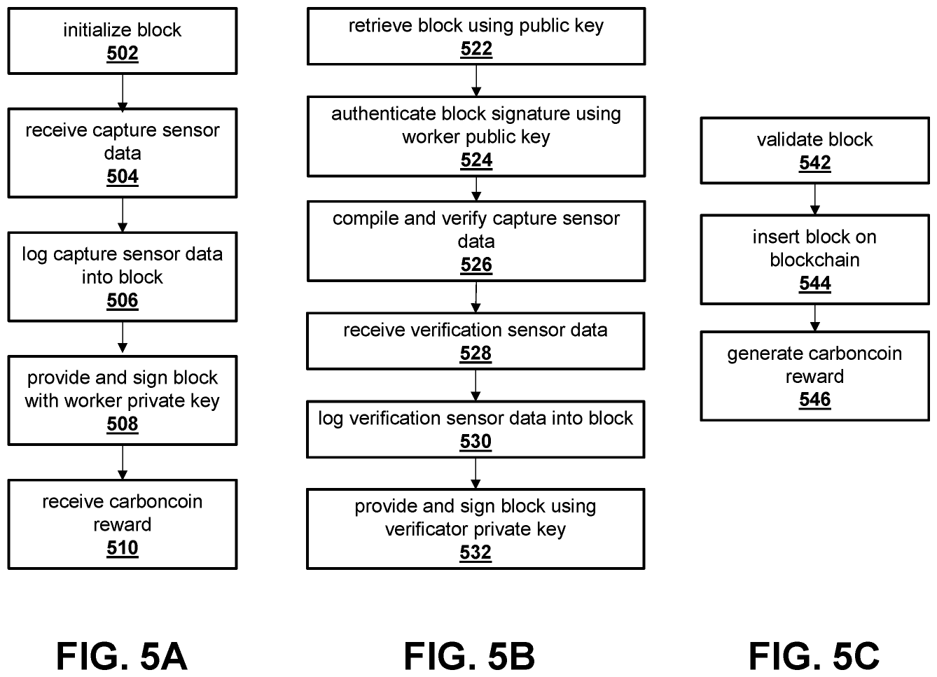

In addition to FIG. 3, reference will also be made to the flowchart of FIG. 5A, which illustrates a method 500 performed by the processor of the worker node 235 (i.e., first node).

According to processing step 502, the worker node 235 initializes a block 320 in a local version of the blockchain 310. It will be appreciated that the blockchain 310 may include previously forged blocks, and the worker node 235 may initialize the block 320 based on a previous hash 322 of the previous block 318. In one or more alternative embodiments, the worker node 235 may initialize the block 320 based on different methods, which depends on how the blockchain 310 is implemented. The worker node 235 maintains a local version of at least a portion of the blockchain 310 until the initial block is provided to other nodes.

In one or more embodiments, the worker node 235 may initialize the block 320 asynchronously, for example in response to receiving an indication from the gas capture apparatus 220 including the plurality of sensors 225, or may initialize the block 320 synchronously based on a predetermined schedule (e.g., capture schedule of the gas capture apparatus 220).

Upon the gas capture apparatus 220 initiating capture of the greenhouse gases from the gas emitting entity 212, the plurality of sensors 225 begin transmitting, at a first point in time, gas capture sensor data 342 to the worker node 235, which may be stored, at least temporarily, by the worker node 235. It will be appreciated that prior to transmission of data, the worker node 235 may authenticate the gas capture apparatus 220 and the plurality of sensors 225.

According to processing step 504, the worker node 235 continuously receives gas capture sensor data 342 transmitted by the plurality of sensors 225 of the gas capture apparatus 220 over the communication link.

According to processing step 506, the worker node 235 begins logging the gas capture sensor data 342 into the block 320 in a local version of the blockchain 310. It will be appreciated that processing step 504 and processing step 506 may be executed in real time or almost real time (i.e., data is streamed and written into the block as it is received).

The worker node 235 receives and logs the gas capture sensor data 342 until a second point in time. In one or more embodiments, the second point in time may correspond to a threshold capacity associated with the gas capture apparatus 220 and/or the one or more containers storing the captured gas. In one or more other embodiments, the second point in time may be determined by an operator of the worker node 235 and/or the gas capture apparatus 220. The block 320 now comprises, in addition to the previous hash 322 and the timestamp 324, an indication of the capture sensor data 326.

According to processing step 508, the worker node 235 provides and signs the block 320 using its worker private cryptographic key 337 to obtain an initialized block 320 (not separately numbered). The initialized block 320 now includes the previous hash 322, a timestamp 324, gas capture sensor data 326 and the worker node signature 328. It will be appreciated that in some embodiments of the present technology, the structure of the initialized block 320 may be different so as to minimize data accumulation in the blockchain 310. As a non-limiting example, an indication of the gas capture sensor data 326 may be logged into the block, e.g., a compressed form of the gas capture sensor data 326, such that it can be decompressed after by other nodes to minimize usage of computational resources.

As a non-limiting example, the initialized block 320 may include the following data:

[{timestamp,
Electrical Conductivity,
temperature,
pressure,
GHG concentration,
airFlow measurement
}]

Once it is signed and transmitted by the worker node 235, the initialized block 320 has a pending status on the blockchain 310. The initialized block 320 is sent to the participating nodes on the network (e.g., via communication network 245). The initialized block 320 is placed in a queue in the blockchain 310 for processing thereof. It will be appreciated that nodes in the blockchain system 300 may receive the block 320 and be notified of the status.

It will be appreciated that method 500 may be executed at the same time or different times by each of a plurality of worker nodes to generate respective blocks based on respective sensor data from during capture of greenhouse gases emitted by respective gas emitting entities 210.

In addition to FIG. 3 and FIG. 5A, reference is made to the flowchart of FIG. 5B, which illustrates a method 520 performed by the processor of the verificator node 262 (i.e., a second node).

In one or more embodiments, the verificator node 262 receives an indication of the initialized block 320 with pending status on the blockchain 310. In one or more embodiments, the verificator node 262 may verify the status of the blockchain 310, or may receive an indication from the worker node 235 or other nodes in the blockchain system 300.

According to processing step 522, the verificator node 262 accesses the data stored in the initialized block 320. In one or more embodiments, the verificator node 262 accesses or retrieves the data based on the unique id associated with the worker node 235.

According to processing step 524, the verificator node 262 authenticates the initialized block 320. In one or more embodiments, the verificator node 262 authenticates the initialized block 320 by verifying the signature of the worker node 235 using the worker public key 339 associated with the worker private key 337 of the worker node 235 to ensure that the worker node 235 has generated the capture sensor data 326.

In one or more embodiments, processing steps 522 and 524 may be executed simultaneously and the verificator node 262 may access the data in the initialized block 320 and authenticate the initialized block 320 by using the worker public key 339 associated with the given gas capture apparatus 220/worker node 235.

According to processing step 526, the verificator node 262 compiles and verifies the capture sensor data 326. The verificator node 262 thus determines at least an approximate indication of a quantity of greenhouse gas captured by the gas emitting entity 212 using the gas capture apparatus 220. In one or more embodiments, the verificator node 262 may compare the at least approximate indication of a quantity of greenhouse gases with an actual unloaded quantity of greenhouse gas to obtain a quantity correlation therebetween. In one or more alternative embodiments, the comparison may be performed by at least one of the verificator node 262 and the validator nodes 270.

In one or more embodiments, the verificator node 262 uses mathematical models and/or machine learning (ML) models having been trained to determine and confirm the quantity of captured greenhouse gases based on at least the capture sensor data 326.

The captured greenhouse gas is received by the gas verification apparatus 250 over the gas transport network 240. Subsequently, the gas verification apparatus 250 begins the unloading process of the captured greenhouse gases and the plurality of verification sensors 255 perform measurements thereon. In one or more embodiments, the gas verification apparatus 250 provides an indication that unloading has begun to the verificator node 262. It will be appreciated that the greenhouse gas may be at least partially unloaded by the gas verification apparatus 250 for verification and then provided for industrial processing and/or stored permanently, without however being released in the atmosphere as a greenhouse gas.

It will be appreciated that the captured greenhouse gases may be received at any time before processing steps 522, 524 or 526.

According to processing step 528, the verificator node 262 receives gas verification sensor data 352 from the plurality of verification sensors 255 of the gas verification apparatus 250.

According to processing step 530, the verificator node 262 logs the gas verification sensor data 352 into the block 320 in the blockchain 310, similarly to how the capture sensor data 342 was written into the block 320 by the worker node 235 as the indication of the capture sensor data 326. Such as block may be referred to as a logged block (i.e., logged with sensor data but not yet signed by the verificator node 262). It will be appreciated processing step 528 and processing step 530 may be executed in real time or almost real time, where data is streamed into the block 320. In one or more other embodiments, the verificator node 262 may not log the gas verification sensor data 352 directly but may log other data generated based on the gas verification sensor data 352. The block 320 now comprises, in addition to the previous hash 322, the timestamp 324, the indication of the capture sensor data 326 and the worker signature 328, an indication of the verification sensor data 330.

According to processing step 532, the verificator node 262 signs the block 320 using the verificator private key 367 to obtain an authenticated logged block 320 (not separately numbered). The authenticated logged block 320 now comprises, in addition to the previous hash 322, the timestamp 324, the indication of the gas capture sensor data 326 and the indication of the gas verification sensor data 330, a verificator signature 332.

The authenticated logged block 320 is provided on the blockchain 310 for validation by other verificator nodes (i.e., referred to as validator nodes).

The authenticated logged block 320 is validated upon successfully completing a validation blockchain cycle based on a smart standard per node, which is the validation between the physical sensor data and the compiled digital data (i.e., including, or based on gas capture sensor data 326 and gas verification sensor data 352 data written into the block 320). As a non-limiting example, a weight or volume of captured greenhouse gas during capturing of the gas by the gas capture apparatus 220 may be correlated with a weight of the same captured greenhouse gas when received and/or unloaded by the gas verification apparatus 250, and the compiled digital data in the block 320 may be correlated and/or verified using different type of models to ensure a correspondence between the captured greenhouse gas and the unloaded greenhouse gas. As another non-limiting example, the physical presence of the container comprising the captured greenhouse gas originating from the gas capture apparatus 220 may be validated by the gas verification apparatus 250, another apparatus or a human worker associated thereto and the compiled digital data including the gas capture sensor data 326 and gas verification sensor data 352 in the block 320 may be correlated and/or verified using different type of models.

In addition to FIG. 3, FIG. 5A, and FIG. 5B, reference is made to the flowchart of FIG. 5C, which illustrates a method 540 performed by the processor of each validator node 272, 274 (i.e., other verificator nodes in the blockchain system 300)

As stated herein above, the blockchain system 300 comprises one or more other verificator nodes, which are referred to as validator nodes 270 (best seen in FIG. 2). The validator nodes 270 are verificator nodes 260 (which may or may not be associated with respective gas verification apparatuses) that participate in the blockchain system 300 but that did not perform physical unloading and verification of the captured greenhouse gases. Each validator node 272 participates in a validation process to form a consensus on the block 320. The consensus enables confirming the capture and unloading of the greenhouse gas to generate a cryptocurrency coin as a reward to the entity associated with the gas emitting entity 212 using the gas capture apparatus 220. It will be appreciated that the number of validator nodes 270 is not limited.

According to processing step 542, each validator node 272, 274 validates the block 320. Each validator node 272, 274 retrieves the block 320 signed by the worker node 235 and the verificator node 262. Each validator node 272, 274 authenticates the block 320 using the worker public key 339 associated with the worker node 235 and the verificator public key 369 associated with the verificator node 262.

In one or more embodiments, each validator node 272, 274 retrieves data logged in the block 320 and the validator nodes 270 collectively compare the data in the block.

In one or more embodiments, each validator node 272, 274 indicates to other validator nodes 272, 274 that the block 320 is valid after executing processing step 542. When a majority of the validator nodes 270 provide an indication of validity, a consensus is reached. In one or more embodiments, consensus is reached when at least a majority of the validator nodes 270 in the blockchain system have provided an indication of validity. As a non-limiting example, the majority may be considered to be at least 50% of the validator nodes 270.

In one or more embodiments, each validator node 272, 274 signs the block using its respective private validator key 377 upon providing an indication of validity. It will be appreciated that the signatures of the validator nodes may be authenticated using a respective validator public key 379 associated with the private validator key 377. The block 320 now comprises, in addition to the previous hash 322, the timestamp 324, the indication of the gas capture sensor data 326, the indication of the gas verification sensor data 330 and the verificator signature 332, a validator signature 334.

According to processing step 544, upon consensus of the validator nodes 270, the block 320 is inserted into the blockchain 310.

According to processing step 546, the carboncoin 360 reward is generated in the blockchain 310 by the validator nodes 270 and transmitted to the worker node 235.

Turning back to FIG. 5A, according to processing step 510, the worker node 235 receives the carboncoin 360.

The carboncoin 360 may be traded by the entity associated with the gas emitting entity 212 with other entities on a carbon market based on the blockchain 310.

As a non-limiting example, the carboncoin 360 may be used to reduce carbon taxes set by a government.

The method 500 is then be repeated to verify and validate the next block 340 in the blockchain 310.

One or more embodiments of the present technology provide a blockchain framework and a system that improves transparency, security and traceability in the context of carbon trading and negative emission technologies. By using a standardized system with certified apparatuses and/or sensors and a distributed ledger shared by participating nodes, data related to physical capture and unloading of greenhouse gases is publicly accessible, which improves transparency of the process and trust. The shared data on the ledger uses encryption techniques and can only be updated and/or modified via consensus by validator nodes, thus improving security of the system. The shared data related to capture and unloading of greenhouse gases as well as the trade of the cryptocurrency coins generated therefrom are easy to track and audit, thus providing traceability and authenticity.

As a result, this may enable improving environmental sustainability by encouraging entities (e.g., industries) to participate in the carbon market by implementing negative emission technologies, thereby reducing presence of greenhouse gases in the atmosphere.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A system for converting captured greenhouse gases into cryptocurrency, said system comprising:
a first node comprising a first processor connected to a first plurality of sensors, the first processor being configured for:
initializing a block in a blockchain;
receiving, from the first plurality of sensors, greenhouse gas capture sensor data having been acquired during capture of a given greenhouse gas;
logging an indication of the greenhouse gas capture sensor data into the block to obtain an initialized block; and
providing the initialized block on the blockchain;
a second node connected to the first node, the second node comprising a second processor connected to a second plurality of sensors, the second processor being configured for:
accessing the initialized block in the blockchain;
authenticating the initialized block to obtain an authenticated initialized block;
receiving, from the second plurality of sensors, greenhouse gas verification sensor data acquired during unloading of the given greenhouse gas, the given greenhouse gas having been received by an entity associated with the second node;
logging an indication of the greenhouse gas verification sensor data into the authenticated initialized block to obtain an authenticated logged block; and
providing the authenticated logged block on the blockchain, the authenticated block comprising the indication of the greenhouse gas capture sensor data and the indication of the greenhouse gas verification sensor data;
a third node connected to the second node, the third node comprising a third processor, the third processor being configured for:
accessing the authenticated logged block;
validating the authenticated logged block to obtain a validated block;
inserting the validated block into the blockchain system; and
generating a cryptocurrency coin to be provided to the first node.

2. The system of claim 1, wherein:
the first processor is configured for:
signing the initialized block using a first node private cryptographic key; and wherein
the second processor is configured for:
authenticating the initialized block using a first node public cryptographic key; and
signing the authenticated logged block using a second node private cryptographic key; and wherein
the third processor is configured for:
authenticating the authenticated logged block using a second node public cryptographic key; and
validating the authenticated logged block to obtain the validated block by signing the authenticated logged block using a third node private cryptographic key.

3. The system of claim 2, wherein the second processor is configured for executing said receiving, from the second plurality of sensors, the greenhouse gas verification sensor data acquired during the unloading of the given greenhouse gas in response to:
receiving a confirmation of physical unloading of the given greenhouse gas from the entity associated with the second node.

4. The system of claim 3, wherein the third processor is configured for validating the authenticated block to obtain the validated block in response to:
comparing at least a portion of the indication of the greenhouse gas capture sensor data with at least a portion of the indication of the greenhouse gas verification sensor data to obtain a correlation therebetween.

5. The system of claim 4, wherein
the second processor is configured for providing the authenticated block in response to:
determining, based on the indication of the greenhouse gas capture sensor data, at least an approximate quantity of the given greenhouse gas to be unloaded;
receiving a quantity of unloaded given greenhouse gas; and
comparing at least the approximate quantity of greenhouse gas to be unloaded with the quantity of unloaded greenhouse to obtain a positive quantity correlation therebetween.

6. The system of claim 5, wherein the second processor is further configured for:
logging the approximate quantity of greenhouse gas to be unloaded, the quantity of unloaded greenhouse gas and the quantity correlation into the authenticated logged block.

7. The system of claim 6, further comprising:
a fourth node, the fourth node comprising a fourth processor, the fourth processor being configured for:
accessing the authenticated logged block;
comparing at least one of the indication of the greenhouse gas capture sensor data and the indication of the greenhouse gas verification sensor data in the authenticated block with the third node; and
upon said comparing resulting in a positive outcome,
signing the authenticated logged block; and
transmitting a confirmation to the third processor, the confirmation thereby causing said validating of the authenticated logged block to obtain the validated block.

8. The system of claim 7, wherein
the third processor is configured for:
comparing the at least one of the greenhouse gas capture sensor data and the greenhouse gas verification sensor data in the authenticated block with the fourth node having accessed the authenticated block; and
obtaining a confirmation from the fourth node, the confirmation thereby causing said validating of the validating the authenticated block to obtain the validated block.

9. The system of claim 8, further comprising a plurality of further nodes each comprising a respective processor, each respective processor being configured for:
accessing the authenticated logged block;
comparing the at least one of the indication of the greenhouse gas capture sensor data and the indication of the greenhouse gas verification sensor data in the authenticated logged block with each of at least the third processor and the fourth processor having accessed the authenticated block; and
upon said comparing resulting in a positive outcome,
signing the authenticated logged block; and
transmitting a confirmation to the third processor, the confirmation thereby causing said validating of the authenticated logged block to obtain the validated block.

10. The system of claim 9, wherein said validating is executed upon receiving a confirmation from at least 50% of nodes.

11. The system of claim 10, wherein:
the first node is associated with a gas capture apparatus, the gas capture apparatus comprising the first plurality of sensors, the gas capture apparatus being configured for capturing the greenhouse gases; and wherein
the second node is associated with a gas verification apparatus, the gas verification apparatus comprising the second plurality of sensors, the gas verification apparatus being configured for unloading and verifying the greenhouse gases captured by the gas capture apparatus.

12. The system of claim 11, wherein the greenhouse gas capture sensor data comprises at least one of: electroconductivity, temperature, concentration, airflow, and pressure measured during capture of the given greenhouse gas.

13. A method for converting captured greenhouse gases into a cryptocurrency, said method comprising:
initializing, by a first node, a block in a blockchain system;
receiving, by the first node from a first plurality of sensors, greenhouse gas capture sensor data having been acquired during capture of a given greenhouse gas;
logging, by the first node, an indication of the greenhouse gas capture sensor data into the block to obtain an initialized block;
providing, by the first node, the initialized block;
accessing, by a second node, the initialized block;
authenticating, by the second node, the initialized block to obtain an authenticated block;
receiving, by the second node from a second plurality of sensors, greenhouse gas verification sensor data having been acquired during unloading of the given greenhouse gas, the given greenhouse gas having been received by an entity associated with the second node;
logging, by the second node, an indication of the greenhouse gas verification sensor data into the authenticated block to obtain an authenticated logged block;
providing, by the second node, the authenticated logged block, the authenticated logged block comprising the indication of the greenhouse gas capture sensor data and the indication of the greenhouse gas verification sensor data;
accessing, by at least a third node, the authenticated logged block;
validating, by at least the third node, the authenticated logged block to obtain a validated block;
inserting, by the third node, the validated block into the blockchain; and
generating, by at least the third node, a cryptocurrency coin to be provided to the first node.

14. The method of claim 13, further comprising, prior to said inserting the validated block into the blockchain:
signing, by the first node, the initialized block using a first node private cryptographic key;
authenticating, by the second node, the initialized block using a first node public cryptographic key;
signing, by the second node, the authenticated logged block using a second node private cryptographic key;
authenticating, by the third node, the authenticated logged block using a second node public cryptographic key; and
signing, by the third node, the validated block using a third node private cryptographic key.

15. The method of claim 14, wherein said receiving, from the second plurality of sensors, the greenhouse gas verification sensor data acquired during the unloading of the given greenhouse gas is executed in response to:
receiving a confirmation of physical unloading of the given greenhouse gas.

16. The method of claim 15, wherein said validating the authenticated block to obtain the validated block is executed in response to:
comparing, by the third node, at least a portion of the greenhouse gas capture sensor data with at least a portion of the greenhouse gas verification sensor data to obtain a correlation therebetween.

17. The method of claim 16, wherein
said providing, by the second node, the authenticated block is performed in response to:
determining, by the second node, based on the greenhouse gas capture sensor data, at least an approximate quantity of greenhouse gas to be unloaded;
receiving, by the second node, a quantity of unloaded greenhouse gas; and
comparing, by the second node, at least the approximate quantity of greenhouse gas to be unloaded with the quantity of unloaded greenhouse to obtain a positive quantity correlation therebetween.

18. The method of claim 17, further comprising:
logging the approximate quantity of greenhouse gas to be unloaded, the quantity of unloaded greenhouse gas and the quantity correlation into the authenticated block.

19. The method of claim 18, further comprising, prior to said inserting the validated block into the blockchain:
accessing, by a fourth node, the authenticated block;
comparing, by the fourth node, at least one of the greenhouse gas capture sensor data and the greenhouse gas verification sensor data in the authenticated block with the third node; and
upon said comparing resulting in a positive outcome,
signing, by the fourth node, the authenticated block; and
transmitting, by the fourth node, a confirmation to the third processor, the confirmation thereby causing said validating of the authenticated block to obtain the validated block.

20. The method of claim 19, further comprising, prior to said inserting the validated block into the blockchain:
comparing, by the third node, the at least one of the greenhouse gas capture sensor data and the greenhouse gas verification sensor data in the authenticated block with a fourth node having accessed the authenticated block; and
obtaining, by the third node, a confirmation from the fourth node, the confirmation thereby causing said validating of the validating the authenticated block to obtain the validated block.
